(19) United States
(12) Patent Application Publication
(10) Pub. No.: US 2011/0071946 A1
(43) Pub. Date: Mar. 24, 2011

(54) CREDIT APPLICANT AND USER AUTHENTICATION SOLUTION

(75) Inventor: Brad Handler, Palo Alto, CA (US)

(73) Assignee: Credit Lock, LLC, Denver, CO (US)

(21) Appl. No.: 12/953,216

(22) Filed: Nov. 23, 2010

Related U.S. Application Data
(62) Division of application No. 11/265,506, filed on Nov. 3, 2005.
(60) Provisional application No. 60/706,036, filed on Aug. 8, 2005.

(51) Int. Cl. G06Q 40/00

(52) U.S. Cl. 705/44; 705/35

(57) ABSTRACT

The present invention provides a credit applicant and user authentication solution for authenticating the identity of a credit applicant or a credit user. In particular, a user of the authentication system establishes a user account and obtains authentication information. The user then provides the authentication information during a subsequent credit application or credit transaction to authenticate the user's identity. Authentication information may be renewed after each application or transaction at specified time intervals, based on monetary thresholds, specific geographic limitations, or any other methodology specified by the user.

### CROSS-REFERENCE TO RELATED APPLICATIONS

This application is a Division of U.S. patent application Ser. No. 11/265,506, filed on Nov. 3, 2005, which claims the benefit of Provisional Patent Application No. 60/706,036, filed Aug. 8, 2005, which applications are incorporated herein by reference in their entirety.

### BACKGROUND OF THE INVENTION

1. Field of the Invention

The present invention relates to a method and system for credit applicant and use identity authentication, and more particularly, to a method and system for authenticating a credit applicant and credit user to protect against identity fraud.

2. Discussion of the Related Art

Current methods of obtaining credit focus primarily on the ability to make a credit decision quickly rather than ensuring the accuracy of the information provided by a credit applicant. Some methods even include tolerances for errors within the information provided. Accordingly, current methods for obtaining credit may be insecure and fraught with opportunities for an unscrupulous individual to obtain credit in the name of another using personal information improperly obtained about that person. Improperly obtaining credit in the name of another is sometimes referred to as “credit fraud” or “identity theft.” Credit fraud and identity theft are also an issue when a user attempts to use credit once it is obtained.

A credit card or credit line is typically obtained through a process in which an applicant provides a variety of personal or private information on a credit application, such as a Social Security number, drivers license number, date of birth, mother's maiden name, etc. The application is provided to a credit provider, such as a retail store, credit card company, mortgage broker or lender, among others, and the credit provider obtains a “credit report” or “credit history” from a credit bureau. If the credit report meets the requirements of the credit provider, credit will be made available to the applicant; otherwise, credit will be denied.

In one such product, a credit provider forwards a user's social security number, mother's maiden name, and answers to a variety of other user specific information to a credit bureau. Authentication of the user is then based on sophisticated data analysis of data collected from multiple sources, as well as advanced neural network and other statistical modeling techniques. After a user is authenticated, a credit history and “credit score” are provided to the credit provider for analysis.

Because the Social Security number of an individual does not change over time, the Social Security number is prevalent in many individual business transactions for identifying an individual. Unfortunately, an individual's Social Security number is often known by others, can appear on various everyday documents, and is otherwise susceptible of being stolen and used by others in an unauthorized manner. Difficulties also arise from the inability or limited ability to change an individual's Social Security number once it has been used improperly. Similarly, an individual's mother's maiden name is also static and can be easily obtained and used to falsify a person's identity.

An individual may be able to obtain another person's credit report once they have their Social Security number and some basic identifying information. The credit report typically provides an applicant's current debt load, payment history, and a credit score based on the information contained in the applicant's credit history, which is used by the credit provider to determine an applicant's credit worthiness. The credit provider will typically provide credit if the credit report shows that the applicant meets certain minimum criteria; otherwise, the credit provider will deny credit to the credit applicant.

Credit providers often rely on the credit bureau to identify a fraudulent attempt at obtaining credit. Even so, an applicant's identity is verified only to the extent that the applicant provides information consistent with that on file at the credit bureau, which may be nothing more than a Social Security number that matches or in some cases closely matches the individual associated with other information provided, such as a mother's maiden name. A picture identification may also be required by the credit provider to assist in the authentication process. However, it is apparent that current efforts to stop credit fraud are often easily defeated by simply providing the Social Security number and/or mother's maiden name of another person and a false picture identification.

Similarly, when an individual uses credit, a credit card or other transaction item, such as a check payable through a line of credit, is all that may be required to make a purchase. Loss or theft of the credit card or check would allow anyone else to use it for their own purposes. In some instances only a credit card number is required to make a purchase. For example, internet purchases or purchases over the phone only require the card number and a three-digit security code, also located on the credit card, and there is no way of knowing who is actually making the purchase. A picture id may be requested when making a purchase in person; however, as discussed earlier, a false picture identification may simply be used.

In today's information-rich society, personal information about others is easily obtainable through a variety of sources. For example, information may be obtained via the Internet, an employee of a credit provider may simply copy the necessary information from an applicant's credit application and use it later to obtain credit for his or herself in the applicant's name, or an application, bill, or other paper that is carelessly thrown away could be picked up by another and used to improperly obtain credit.

In some instances credit bureaus will block access to a specific person's credit history, but this is typically avoided by the credit bureaus except in situations where an individual has already suffered from an identity theft. Furthermore, there are time consuming hurdles involved with accessing one's credit history once a block has been placed that may limit a person's ability to obtain credit and take advantage of time-sensitive situations.

Credit providers may contact a customer if a purchase pattern flags possible misuse of a card, but this is done only after the activity has been detected. Additionally, current fraud detection mechanisms may not even identify most fraudulent activity, thus placing responsibility on the consumer to identify fraudulent purchases by closely reviewing their monthly statement.

These and other deficiencies exist in conventional credit application and use systems and methods. Therefore, a solution to these and other problems is needed, providing a secure credit application and use system and method specifically designed to protect a credit applicant from identity theft and credit fraud whether or not their personal information has been improperly obtained by others.

### SUMMARY OF THE INVENTION

Accordingly, the present invention is directed to a credit application and use identity authentication solution for protecting an individual's credit history, credit account, and credit-related information from unauthorized users. The advantages of the invention will be realized and attained by the structure particularly pointed out in the written description and claims hereof, as well as the appended drawings.

Thus, the present invention provides an authentication solution limiting access to an individual's credit history and/or an individual's established credit account. The limited access is enforced by the creation of an authentication account and providing renewable authentication information to the individual and requiring that the individual provide current authentication information to validate the individual's identity before a credit history is made available or use of existing credit is authorized. Accordingly, authentication information, such as a personal identification number (PIN), password, or biometric information, is used to verify the user's identity and is known by the user and not known, knowable, or reproducible by others. Furthermore, authentication information may be provided and validated as part of the credit application or credit transaction process, thus securing a credit history or access to a credit account without inhibiting the speed of a credit application or transaction.

Authentication information is provided to or created by the user upon establishing an authentication account. Thereafter, authentication information must be renewed according to established business rules associated with the user's authentication account. For example, a business rule may require renewal of the authentication information after a certain number of uses, after each transaction over a specified monetary limit, or after each transaction within a certain geographic area. Further business rules may also require that notice is provided to a user before or after specified types of transactions, for example. Business rules may be set by the authentication solution or may be user configurable.

Accordingly, in one embodiment of the present invention, an authentication solution architecture is provided including a user access layer enabling one or more user devices to provide and receive data within the authentication solution architecture, a user interface interconnected with the user access layer for providing interface modules for interacting with the one or more user devices, a user services layer interconnected with the user interface layer for providing authentication services and associated services, and a data storage layer interconnected with the user services layer for storing and providing data to the authentication services and associated services.

In a further embodiment of the present invention, an authentication system for authenticating a user's identity is provided, including one or more access points for communicating with user entry devices, an account management server interconnected with the one or more access points for establishing an authentication account for a user, creating authentication information associated with the authentication account, and renewing the authentication information based on a set of business rules, an authentication server interconnected with the one or more access points for comparing authentication information with transaction authentication data provided during a transaction and validating a user's identity if the transaction authentication information matches the user's authentication information, and a storage server interconnected with the account management server and authentication server for storing authentication account data and a uthentication information.

According to another embodiment of the present invention, a credit authentication solution is provided wherein a credit applicant or credit user, referred to here simply as the user, creates an authentication account and establishes authentication information. When attempting to obtain credit from a particular credit provider the user provides a completed credit application, the credit provider submits necessary information to a credit bureau to obtain the user's credit history, and the credit bureau requests the user's uniquely created authentication information. In one embodiment, a user's credit history is obtained from a credit bureau and upon authenticating the user's identity with valid authentication information, the credit history is released to the credit provider. In a further embodiment, the user is authenticated with valid authentication information then the credit history is either obtained from a credit bureau and released to the credit provider or the credit bureau is instructed to forward the credit history to the credit provider.

When a user attempts to use previously established credit, the user provides credit account information and their authentication information. Upon receiving valid authentication information from the user, the credit provider authorizes the credit transaction. In a further embodiment, the credit provider authorizes a request for a credit transaction.

In the event that invalid authentication information is provided, access to the user's credit history will be denied or the credit transaction will not be initiated or authorized. In a further embodiment the user will also be notified via a phone call, e-mail, instant message, or other suitable communication method that their credit history has been either provided or denied to the particular credit provider or that their transaction has been authorized or not.

In another embodiment of the present invention, a user obtains a master identifier such as a PIN or password. The user then provides the master identifier when creating or modifying authentication information. Accordingly, the user may securely change the authentication information in the event of loss, theft, or in the ordinary course of renewing authentication information.

Accordingly, one aspect of the present invention is to provide renewable authentication information for securely authenticating a user's identity.

Another aspect of the present invention is the use of business rules to configure the manner in which the authentication information is managed and used to authenticate the user's identity, such as identifying the duration of time, number of transactions, or geographic locations in which authentication may be used before renewal.

A further aspect of the present invention is the use of business rules to configure the functionality of a user's authentication account, such as identifying when and how account activity notifications are sent to the user.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof, as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a credit authentication solution architecture, according to an embodiment of the present invention;

FIG. 2 shows a block diagram of the credit authentication solution, according to an embodiment of the present invention;

FIG. 3 shows a process flow diagram for authenticating a credit applicant, according to an embodiment of the present invention; and

FIG. 4 show a process flow diagram for authenticating a credit user, according to an embodiment of the present invention.

### DETAILED DESCRIPTION OF VARIOUS EMBODIMENTS

Reference will now be made in detail to various embodiments of the present invention, examples of which are illustrated in the accompanying drawings.

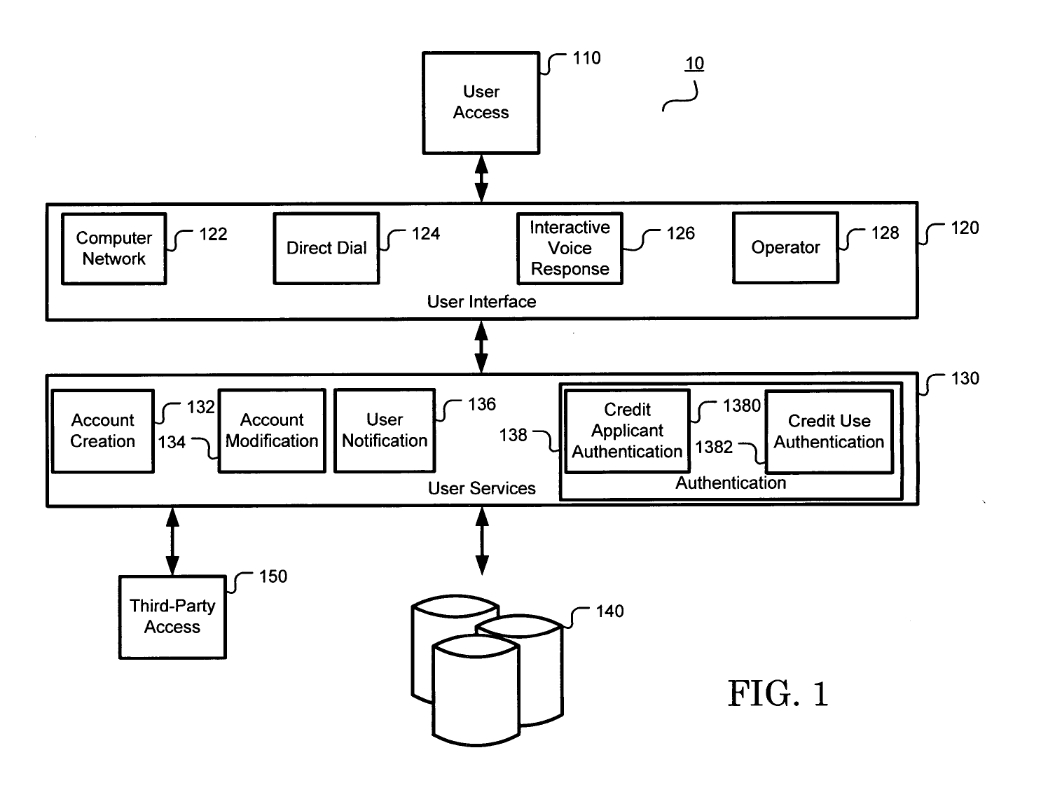

FIG. 1 shows a credit authentication solution architecture, according to an embodiment of the present invention. According to the embodiment shown in FIG. 1, credit authentication solution architecture 10 includes a user access layer 110, user interface layer 120, and user services layer 130. Credit authentication solution architecture 10 provides the communication, processing, and data storage capabilities for creating an authentication account and authentication information, modifying an authentication account and authentication information, authenticating the identity of a user, and providing information to the user.

The user access layer 110 provides the communication point between the credit authentication solution architecture 10 and a user. According to various embodiments, a user may be a consumer or credit applicant creating or modifying an existing authentication account, a credit provider during the credit application process, a merchant during credit use transaction, or any individual or business entity authorized to access the credit authentication solution architecture 10 on behalf of a consumer or credit applicant. According to various embodiments of the present invention, the user access layer includes voice access, such as telephone or voice over internet protocol (“VOIP”) connections, as well as data access, including computing devices, such as desktop or laptop computers, handheld computing devices and biometric input devices, for example.

The user interface layer 120 of credit authentication solution architecture 10 provides the various interfaces and modules for interacting with the devices available through user access module 110. The user interface layer 120 provides access via voice or data communication devices, such as via telephone, computer, or biometric devices. According to the embodiment shown in FIG. 1, interface layer 120 includes a computer network module 122, a direct dial module 124, an interactive voice response module 126, and an operator module 128. Computer network module 122 provides a user interface for users connecting through a personal computer, smartphone, or other computing device sending data over a computer network, such as the Internet, for example. Direct dial module 124 provides an interface for users connecting directly to the credit authentication solution architecture 10 over a telephone line or other direct line of communication.

Interactive voice response module 126 and operator module 128 each provide an interface for users 110 accessing the authentication architecture 10 via a telephone, cell phone, or other data entry device. The interactive voice response module 126 provides an automated communication system allowing a user to access various menus through voice commands and/or keypad entry. Operator module 128 provides an operator to assist a user 110.

The user services layer 130 provides user service modules for the services associated with the credit authentication architecture 10. User services layer 130, as shown in the embodiment displayed in FIG. 1, includes account creation module 132, account modification module 134, user notification module 136, and authentication module 138. According to an embodiment of the present invention, services within user services layer 130 operate within a specified set of business rules. For example, business rules may enforce that authentication information be provided for all authentication transaction, including credit applicant and credit use. A further embodiment may include business rules requiring authentication information for all credit applicant transactions and any credit use transaction above a specified dollar amount. Another embodiment may include a set of business rules requiring authentication information for any credit use transaction within a specified geographic area, for example, all transactions outside of the United States. Further embodiments may provide for a wide variety of business rule configurations.

In a further embodiment of the present invention, business rules are established for managing the requirements and functionality of an authentication account. For example, business rules may dictate under what criteria authentication information is required, such as any transactions above a specified monetary amount or within a specific geographic location. Business rules may also indicate how often authentication information must be renewed, such as after a specified number of transactions, specified number of days, or some other timeframe. Business rules my be implemented on a system-wide basis or user configurable.

According to one embodiment, user established business rules are maintained in a user profile associated with the user's authentication account. Business rules may also establish when and a how a user is notified of account activity.

The account creation module 132 provides the processes and data for creating a user account for authenticating a user's identification when obtaining and/or using credit. The account creation module 132 obtains a user's information through the user interface layer 120 and provides authentication information to the user once a user account has been successfully created. The user later provides authentication information according to the established set of business rules.

In a further embodiment, account creation module 132 may allow the creation of a group account, such as a business or family account. In such an embodiment a group account includes one or more individuals identified as primary users and one or more users identified as secondary users. Accordingly, the one or more primary users may create business rules under which the one or more secondary users are to use authentication information when using the group account. For example, a primary user may set rules to require authentication information for any credit use transaction over a specified monetary amount, such as $100, within the United States, for example, and for any transaction outside the United States.

The account modification module 134 provides the processes and data for modifying a user account, such as, the name, address, phone number, e-mail address, account user name, or an account profile. Additionally, the account modification module 134 provides the processes and data for updating authentication information. Accordingly, various embodiments of account modification module 134 update authentication information according to existing business rules or business rules established by the user.

The user notification module 136 provides the processes and data for notification to a user of transactions or actions associated with a user's account. For example, in one embodiment, a user is notified when the user's authentication account information is used or modified. In another embodiment, a user is notified when an attempt is made to access the user's account, such as, an attempt to access a credit account. In a further embodiment in which group accounts are provided, one or more primary users are notified of secondary account activities. User notification module 136 provides additional security for the user's account by allowing the user an opportunity to verify and track account usage.

According to a further embodiment, the user notification module 136 generates and sends an e-mail message to the user. In a further embodiment, the user notification module 136 generates a message to a customer service representative who calls the user with the transaction information. In a further embodiment, the user establishes a business rule identifying the types of transactions and the preferred method in which the user will be contacted.

The authentication module 138 provides the processes and data for authenticating a user's identity when a user attempts to establish a new credit account, such as a credit card account, car loan, mortgage, or home equity line, among others, or during a credit use transaction, such as a credit card or debit purchase, an equity-line check use, or a pre-approved mortgage transaction, for example. In a further embodiment, the authentication module 138 may include credit applicant authentication module 1380 and credit use authentication module 1382 to provide dedicated modules for the authentication services of authentication module 138.

As shown in FIG. 1, the authentication module 138 and the credit applicant authentication module 1380 in particular provide the processes and data for authenticating the identity of a credit applicant. During the credit application process, an applicant provides application information, as well as the applicant's authentication information. This information is provided to credit applicant authentication module 1380, which compares the information with that associated with the applicant's authentication account to validate or invalidate the applicant's identity.

The authentication module 138 and the credit use authentication module 1382 in particular provide the processes and data for authenticating a user when the user attempts to use an established credit account. During a credit use transaction, information identifying the consumer, such as a credit card number, and authentication information are provided to the credit use authentication module 1382. The credit use authentication module 1382 obtains authentication account information for the consumer based on the data supplied and compares the authentication information with that associated with the consumer's authentication account to validate or invalidate the consumer's identity. If validated, the transaction is allowed to proceed.

The credit authentication solution architecture 10, as shown in FIG. 1, further includes data storage 140 interconnected with user services layer 130. Data storage 140 maintains data obtained and created by the various service modules of user services layer 130, including authentication account information and authentication information. In a further embodiment, data storage 140 maintains a user's credit history or credit report. In another embodiment, data storage 140 maintains credit account data, for example, credit limits, and purchase and payment data. In a further embodiment, data storage 140 maintains a user's credit history and transaction history matrix allowing further analysis and review for any other possibilities of fraudulent use of a user's account.

It will be apparent to one skilled in the art that the present invention may be used to protect any type of sensitive data. For example, in a further embodiment, data storage 140 may contain sensitive business information accessible only by those able to authenticate their identification through authentication module 138.

In a further embodiment of the present invention, a third-party access module 150 is provided for communicating with third-party providers, such as credit bureaus or credit providers. For example, in one embodiment of the present invention, when a credit applicant authentication is requested and validated, a credit bureau is contacted to authorize the release of the applicant's credit history. In a further embodiment, a credit provider is contacted to validate or deny access to a consumer's credit account.

According to a further embodiment of the present invention, a third-party provider returns a message to the credit authentication solution architecture 10 providing the necessary information to complete the transaction. For example, in one embodiment, when credit applicant authentication is provided to a credit bureau, the credit bureau returns a message with the user's credit report, thus allowing the user services layer 130 to generate a message with the required information for the user to complete their application process. In a further embodiment, a third-party provider may forward information directly to the user.

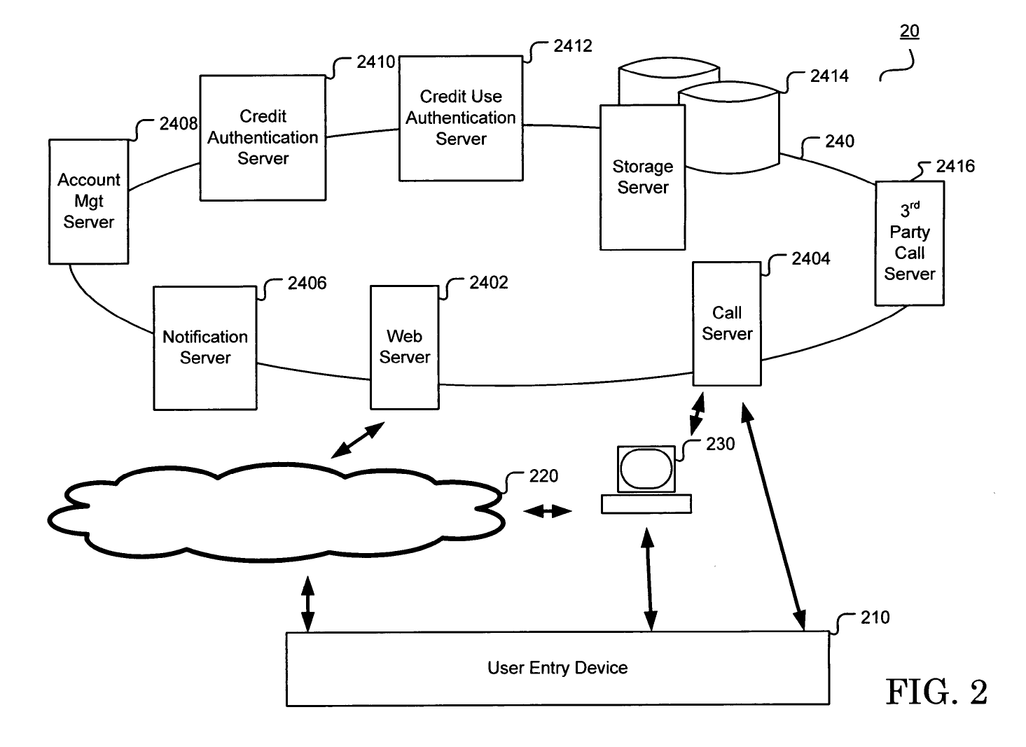

FIG. 2 shows a block diagram of a credit authentication solution, according to an embodiment of the present invention. The credit authentication solution 20, as shown in FIG. 2, includes a credit authentication network 240 and one or more user entry devices 210 for communicating with the credit authentication network 240. The credit authentication network 240 allows a user to create and modify an authentication account, receive and update authentication information, receive notification of activities related to the user's authentication account, and present authentication information for identity validation when applying for credit or during credit use transaction. The credit authentication network 240, as shown in FIG. 2, is configured with various servers; however, it can be appreciated by one skilled in the art that the software and hardware providing the described functionality within each of the identified servers could be combined or expanded in a variety of ways without departing from the scope of the present invention. For example, in the simplest configurations, a single server could provide all of the functionality of the credit authentication network 240. As a further, more complex, example, a distributed networking system could provide the functionality of the authentication network 240 where multiple servers are available and able to backup the functionality of any server that may be taken offline.

In FIG. 2, a user accesses the authentication network through user entry device 210. User entry device 210 may include a personal computer, a telephone, point of service device, or biometric entry device, for example. Essentially, any device allowing entry of alphanumeric characters, responses to a menu driven interface, biometric information, or other data associated with a specific user or capable of providing a password or data associated with a specific individual may be used. Furthermore, one device or multiple devices may be used to provide data for a single transaction. For example, a user involved in a credit use transaction may provide credit card data through a scanning device and biometric information, such as a thumbprint, used as authentication information through a separate biometric device to complete the transaction.

According to the embodiment shown in FIG. 2, a user device may connect to the credit authentication network 240 through a computer network 220, a customer service operator 230, or via a direct dial connection. In one embodiment, a connection is made by user entry device 210 through network 220 to web server 2402 of authentication network 240. Computer network 220 may be a wide area network, such as the Internet, or a local area network, such as a network within a business.

According to a further embodiment, user entry device 210 accesses the authentication network 240 through customer service representative 230. In one embodiment, customer service representative 230 interacts with credit authentication network 240 through network 220 to web server 2402. In a further embodiment, customer service representative 230 interacts with credit authentication network 240 through a direct connection with call server 2404. According to another embodiment, user entry device 210 accesses authentication network 240 through call server 2404.

As shown in the embodiment provided in FIG. 2, authentication network 240 includes web server 2402 and call server 2404 as user access points, notification server 2406, account management server 2408, credit authentication server 2410, credit use authentication server 2412, data storage server 2414, and third-party call server 2416. Web server 2402 provides a user access point and security mechanisms between computer network 220 and credit authentication network 240. Web server 2402 also provides a communication interface for user entry device 210. For example, in one embodiment, web server 2402 provides a graphical user interface via a web browser or other presentation mechanism for presenting data to or collecting data from a user. In a further embodiment, customer service representative 230 connects to web server 2402 through network 220 to assist a user with entering data or receiving data from authentication network 240. In a further embodiment, web server 2402 provides virtual private network functionality to ensure a secure connection is maintained between the user entry device 210 and the authentication network 240.

The call server 2404, as shown in FIG. 2, also provides a user access point and security mechanisms for access to the authentication network 240. In one embodiment, call server 2404 includes interactive voice response (“IVR”) technology providing interactive menus controlled with voice commands or data entry. In a further embodiment, call server 2404 provides a graphical user interface allowing a user to dial directly to the user authentication network 240. In further embodiments, customer service representative 230 accesses authentication network 240 through call server 2404 to assist customers with accessing authentication network 240.

The account management server 2408 provides the processes and data for creating or modifying an authentication account and obtain authentication information. A user interacts with account management server 2408 through an access point, such as web server 2402 or call server 2402. In a further embodiment, a user may also establish a user profile. A user profile maintains user preferences and business rules for a variety of activity with the user's authentication account. For example, a user profile may include preferences such as the number of times or duration of time authentication information may be used before it must be changed, geographic locations in which authentication information is required for a transaction, or financial limits in which authentication information is required for a transaction, the type of identification that is required before authentication information may be validated for a particular transaction, when a user should be notified of a transaction, or a preferred method of notifying a user, among other information. The account management server 2408 stores account data, authentication information, and any user profile on storage server 2414.

The account management server 2408 also enables a user's ability to modify account and profile data, as well as create or request renewed authentication information. In one embodiment, a user is required to provide authentication information to modify any information associated with the user's authentication account. In a further embodiment, additional information, such as an account user identification and password are required to modify a user account.

In a further embodiment, a user may configure a group account, such as a business or family account, through account management server 2408. A group account provides an account with one or more primary users and one or more secondary users. Primary users may create and modify profiles for themselves and for the secondary users. For example, a business credit account may be established in which a manager controls the features associated with credit cards assigned to employees supervised by the manager. The manager may create profiles with business rules for each credit card within the business account and require authentication information for specified transactions, such as any transaction above a specified monetary limit, any transaction within or outside of a specified geographical area, or any transaction within or outside of a specific timeframe, among others. In a further embodiment, a primary user may establish a business rule for receiving notifications for specified transactions of secondary users.

It will be apparent to one skilled in the art that the present invention may be used to protect sensitive business information. It will also be apparent that business rules may be established for accessing business information by numerous individuals within a business organization.

The credit authentication server 2410 provides the processes and access to data necessary to validate a user's identity during a credit authentication transaction. A user interacts with credit authentication server 2410 through an access point, such as web server 2402 or call server 2404. During a credit authentication transaction, the credit authentication server obtains information, such as data from a user's credit application. In one embodiment, this information may include the user's authentication information. In a further embodiment, the credit authentication server requests the user's authentication information. Credit authentication server 2410 also obtains the user's authentication account information from storage server 2414, which includes the authentication network's copy of the user's authentication information. The credit authentication server 2410 compares the authentication information provided by the user and the authentication information stored with the user's account to validate the user and provide or allow access to information requested by the credit provider, such as the user's credit history.

According to one embodiment of the present invention, a user's credit history is maintained in storage server 2414. In a further embodiment, a communication is sent via third-party call server 2416 to a credit bureau validating the user's identity and requesting the user's credit history. In one such embodiment, the credit history is allowed to proceed to the authentication network through the third-party call server 2416 where it is forwarded to the credit provider by the authentication network 240. In a further embodiment, a message is sent to the credit bureau validating the user's identity, wherein the credit bureau forwards the credit history directly to the credit provider.

The credit use authentication server 2412 provides the processes and data for authenticating a user during a credit use transaction, such as a credit card purchase, for example. During a transaction, credit card information is provided through an access point such as web server 2402 or call server 2404. For example, in one embodiment, a merchant may provide a user's credit card information, such as the user's name, credit card number, and credit card expiration date. Credit use authentication server 2412 then obtains the user's account data from storage server 2414 to verify the accuracy of the information provided. The credit use authentication server 2412 would then request the user's authentication information. Once the authentication information is provided, the credit use authentication server 2412 verifies the authentication information provided by the user with the authentication information stored with the user's account data. If the authentication information matches, the credit information is validated and a message is returned to the merchant approving the continuation of the transaction.

According to further embodiments of the present invention, the notification server 2406 is used to notify users of activities associated with their accounts. Information may be provided to a user via an e-mail, a phone call from customer service representative 230, or through an automated messaging system via call server 2404.

According to one embodiment, the notification server 2406 contacts user for each transaction associated with the user's account. In further embodiments, a user may establish a user profile identifying the types of transactions in which the user wishes to receive notification, such as transactions over a specified monetary amount or transactions within or outside of a specific geographic area. Further embodiments provide notifications to a primary user of transactions made by secondary users within a group account.

The storage server 2414 provides data storage for the data obtained or created by the various services provided by the authentication network 240. In a further storage server 2414 maintains a user's credit data, such as credit reports or histories, or credit account information.

According to a further embodiment, authentication network 240 also includes third-party server 2416 for communicating with third-party credit vendors, such as credit bureaus or credit providers.

In operation, a user first establishes a credit authentication account by accessing authentication network 240 with user entry device 210. Once an account is established, a user is provided with authentication information for verifying the user's identity when obtaining or using credit. In one embodiment, authentication information may be a password or personal identification number. In a further embodiment, authentication information includes a user identification and a password or personal identification number. In another embodiment, biometric information may be provided in lieu of a password or personal identification number.

When obtaining credit, a user supplies information to authentication network 240 to establish their identity. The user then provides their authentication information to verify their identity. Credit authentication server 2410 obtains the user's authentication account information from storage server 2414 and compares the authentication information supplied by the user with the authentication information stored on storage server 2414. If the authentication information matches, the user's identity is verified and the transaction continues based on the established rules for that particular transaction. For example, the user's credit information, such as their credit history is provided to the user or the credit provider. In one embodiment, the credit information is maintained on a storage server 2414 within authentication network 240.

In a further embodiment, the credit information is maintained by a third-party credit bureau. Accordingly, credit authentication network 240 sends a message validity the user's identity to the third-party via the third-party server 2416. The third-party may provide the credit information directly to the user or the credit provider. In a further embodiment, the third-party returns the credit information to the authentication network 240 for delivery to the user or credit provider.

When using credit, a user supplies credit account information, such as a credit card number, to authentication network 240 to establish their identity. The user also provides their authentication information to verify their identity. Credit use authentication server 2412 obtains the user's authentication account information from storage server 2414 and compares the authentication information supplied by the user with the authentication information associated with the user's credit authentication account and stored on storage server 2414. If the authentication information matches, the user's identity is verified and the user's credit transaction is continued.

In one embodiment, authentication network 240 authorizes the credit transaction. In a further embodiment, the user's credit provider is notified via third-party server 2416.

According to an embodiment of the present invention, after authentication information is used to verify a user's identity, the authentication must be renewed by the user. To renew authentication information a user accesses the credit authentication network 240 via user entry device 210. The user accesses the account management server 2408 to renew authentication information. In a further embodiment, a message is sent via notification server 2406 to remind the user to renew their authentication information. In further embodiments, notification server 2406 notifies the user of the use or attempted use of authentication information.

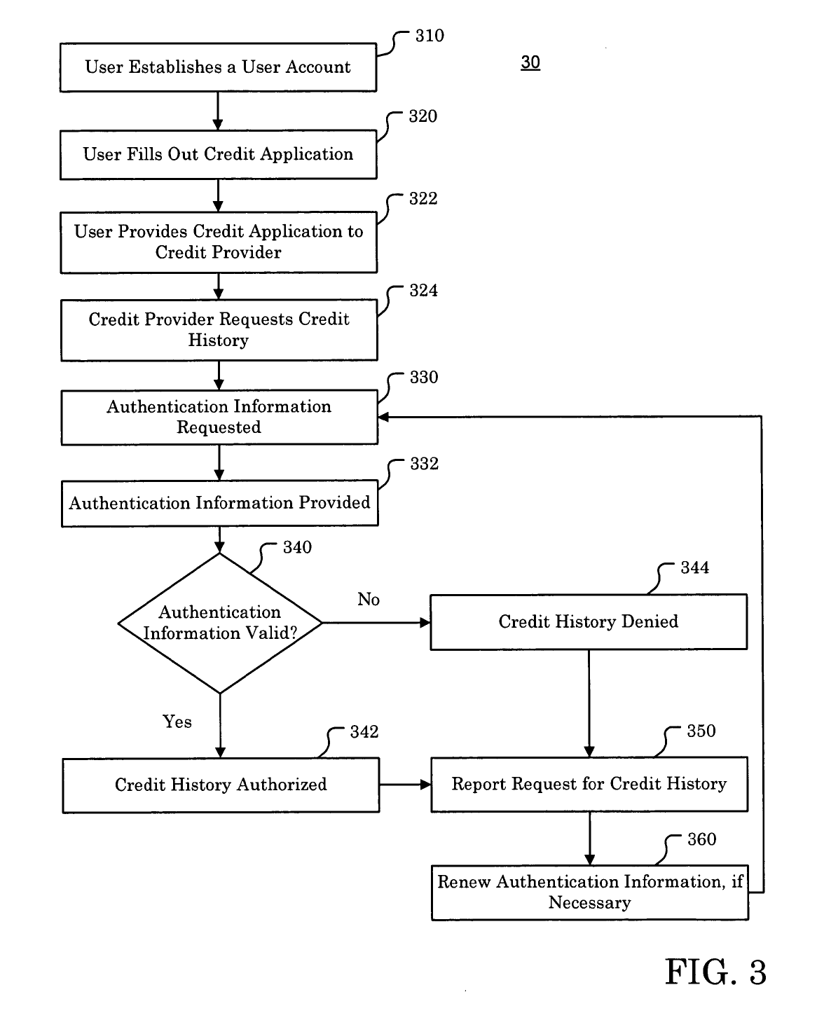

FIG. 3 shows a process flow diagram for authenticating a credit applicant, according to an embodiment of the present invention. In the embodiment shown in FIG. 3, in step 310 a user creates a user account and obtains or creates authentication information. The authentication information created may be a single identification and/or password, or a master identification and/or password for creating a second identification and/or password, such as an instance identification and/or password, wherein the second identification and/or password is used for authenticating the credit applicant and the master identification and/or password is used to regenerate a new second identification and/or password as required by the embodiment of the invention implemented.

In a further embodiment, the applicant may provide biometric information, such as a finger or thumbprint, an iris scan, voice sample, or some other data for uniquely identifying the user. According to various embodiments of the present invention, the biometric information may be used as the individual's identification information or as the master information for obtaining a second identification and/or password.

In a further embodiment, an identification and/or password may also be created and used to access the user's data via a network or other system. For example, a virtual private network (“VPN”) may be used to access an applicant's account for which an identification and/or password are used to enter the VPN.

In step 320 of FIG. 3, the user fills out a credit application. The application may be any type of application used by a credit provider to obtain the necessary information from the user. For example, an application may be a simple form filled out with a pen or pencil, a form provided on-line filled out via a computer terminal, or other device used to obtain information from the user. In step 322, the credit application is then submitted or provided to the credit provider. The application may be submitted in person to the credit provider, provided via an online form, sent via the mail, or other delivery service. For purposes of the present invention the credit provider may be the entity providing credit to the applicant or simply an intermediate entity empowered to process an application on behalf of the entity providing credit.

In step 324, the credit provider requests the credit history of the user as identified on the application form. According to one embodiment the request is made to a credit bureau. In a further embodiment, the request is made to an authentication entity for authenticating a credit applicant's identity.

In step 330, the credit bureau or authentication entity then requests the user's authentication information. Turning to step 332, the user then provides the authentication information directly to the credit bureau or authentication entity or to the credit provider to enter the information on behalf of the user. For example, a user may provide authentication information via a telephone, a key-pad or computer terminal, or may provide biometric information through an appropriate device made available to the user. A user may also provide a password or identification to the credit provider to pass on to the credit bureau or authentication entity.

In step 340, the credit bureau or authentication entity attempts to validate the authentication information. If the authentication information is valid, the process moves to step 342 where the credit history is authorized and provided to the credit provider. In one embodiment, the credit bureau validates the authentication information and provides the credit history to the credit provider. In a further embodiment, the authentication entity validates the authentication information and reports the validation to the credit bureau. The credit bureau may then provide the credit history to the credit provider directly or provide the credit history to the authentication entity, which will then provide the credit history to the credit provider. If the authentication information is invalid, the process moves to step 344 where access to the credit history is denied.

According to the embodiment shown in FIG. 3, whether the authentication information is validated or not, the process continues in step 350 where the credit bureau or authentication entity also reports the results of the authentication process by contacting the user associated with the authentication information used and providing key information, such as the time, date, and location that the request for credit was made, and a reminder to regenerate authentication information, if necessary. The report may be made via phone, mail, e-mail, instant message, or any other method agreed upon by the applicant.

In an embodiment in which authentication information must be renewed one or more reminders may be sent to the applicant to remind him or her that renewal is necessary. Renewal notification may also be provided by phone, mail, e-mail, instant message, or any other method agreed upon by the applicant.

According to one embodiment of the present invention, authentication information is invalidated after it is used and must be renewed before access to the applicant's credit history will be allowed. In a further embodiment, authentication information is invalidated after a specified time period. According to another embodiment, authentication information is invalidated after a specific number of uses. Accordingly, authentication information is renewed in step 360, if necessary, and a user may provide authentication information at step 332 of a subsequent request for credit based on a specified business rule, such as monetary limit or geographic location, for example.

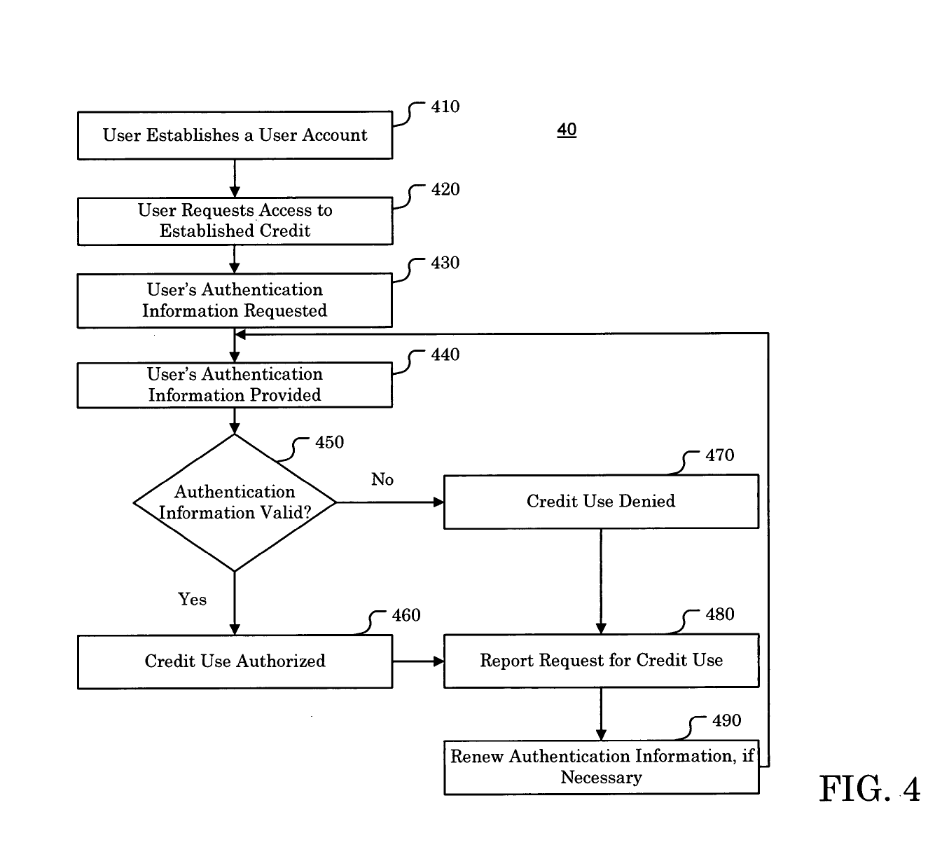

FIG. 4 shows a process flow diagram for authenticating a credit user, according to an embodiment of the present invention. In the embodiment shown in FIG. 4, in step 410 a user creates a user account and creates authentication information with an authentication bureau, which may be a credit bureau or other authentication entity designated for authenticating a user's identity. The authentication information created may be a single identification and/or password, or a master identification and/or password for creating a second identification and/or password, such as an instance identification and/or password, wherein the second identification and/or password is used for authenticating the credit applicant and the master identification and/or password is used to regenerate a new second identification and/or password as required by the embodiment of the invention implemented.

In a further embodiment, the applicant may provide biometric information, such as a finger or thumbprint, an iris scan, voice sample, or some other data for uniquely identifying the user. According to various embodiments of the present invention, the biometric information may be used as the individual's identification information or as the master information for obtaining a second identification and/or password.

In a further embodiment, an identification and/or password may also be created and used to access the user's data via a network or other system. For example, a virtual private network (“VPN”) may be used to access an applicant's account for which an identification and/or password are used to enter the VPN.

In step 420 of FIG. 4, the user requests access to the user's established credit account. For example, a user may present a card or credit-line check to make a purchase or request access to pre-authorized financing, such as a pre-authorized mortgage.

In step 430, the user's authentication information is requested. In step 440, the user provides the authentication information to the authentication entity. In a further embodiment, the user may simply provide the authentication information in step 420 with the request to access the user's credit account. A user may provide authentication information via a telephone, a key-pad or computer terminal, or may provide biometric information through an appropriate device made available to the user. A user may also provide authentication information directly to a retailer to pass on to the authentication entity.

In step 450, the authentication entity attempts to validate the authentication information provided by the user. If the authentication information is valid, the process moves to step 460 where the credit use is authorized and access to the credit account is provided. If the authentication information is invalid, the process moves to step 470 where credit use is denied.

According to the embodiment shown in FIG. 4, whether the authentication information is validated or not, the process continues in step 480 where the authentication entity reports the results of the authentication process by contacting the user associated with the account and authentication information used and providing key information, such as the time, date, and location that the request for credit was made, and a reminder to renew authentication information, if necessary. The report may be made via phone, mail, e-mail, instant message, or any other method agreed upon by the applicant.

In an embodiment in which authentication information must be renewed, one or more reminders may be sent to the applicant to remind him or her that renewal is necessary. Renewal notification may also be provided by phone, mail, e-mail, instant message, or any other method agreed upon by the applicant.

According to one embodiment of the present invention, authentication information is invalidated after it is used and must be renewed before access to the applicant's established credit will be allowed. In a further embodiment, authentication information is invalidated after a specified time period. According to another embodiment, authentication information is invalidated after a specific number of uses. Accordingly, authentication information is renewed in step 490, if necessary, and a user may provide authentication information with a subsequent credit use transaction.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

1. A method for authenticating the identity of a credit user, comprising the steps of:
establishing an authentication account by a user;
generating authentication information associated with the user;
storing a first instance of the authentication information;
passing a second instance of the authentication information to the user;
requesting access to an established credit account by the user;
forwarding by the user the second instance of the authentication information to verify the user's identity; and
authenticating the user's identity by comparing the first instance of the authentication information with the second instance of the authentication information provided by the user.

2. The method of claim 1, further comprising validating the user's identity if the first instance of the authentication information matches the second instance of the authentication information.

3. The method of claim 2, further comprising authorizing access to the user's credit account.

4. The method of claim 3, further comprising reporting to the user the requesting of authorizing access to the user's credit account.

5. The method of claim 2, further comprising renewing the user authentication information if the user's identity is validated in validating the user's identity.

6. The method of claim 1, further comprising invalidating the user's identity if the first instance of the authentication information does not match the second instance of the authentication information.

7. The method of claim 6, further comprising denying access to the user's credit account.

8. An authentication method to authenticate a user, the method comprising:
using one or more computer processors and storage, receiving data from a user, the data including (1) account data to establish a user authentication account, and (2) a set of business rules established by the user to manage the user authentication account;
establishing a user authentication account using the account data; and
managing the user authentication account using the business rules, the managing of the user authentication account including providing authentication services and associated services.

9. The method of claim 8, further comprising providing communication capabilities between the user and third-party providers.

10. The method of claim 8, wherein the authentication services further comprise a credit applicant authentication service.

11. The method of claim 8, wherein the authentication services further comprise a credit use authentication service.

12. The method of claim 8, wherein the associated services further comprise providing user authentication information for the authentication services.

13. The method of claim 8, wherein the associated services further comprise modifying the user authentication account and renewing the user authentication information.

14. The method of claim 8, wherein the associated services further comprise providing information to a user regarding the user authentication account and transactions associated with the users authentication account.

15. The method of claim 8 further comprising:
providing an interface to computers, computing devices, telephony devices and biometric data devices over a computer network, for communication between the user and the one or more computer processors and storage.

16. The method of claim 8, the business rules including a requirement that the user receive notice of a transaction before the transaction is carried out.

17. The method of claim 16 further including prompting the user to enter authentication information in response to the notice of the transaction.

18. The method of claim 16 wherein the transaction is a specified type of transaction.

19. The method of claim 8, the business rules including a requirement that the user receive notice of a transaction after the transaction is carried out.

20. The method of claim 19, wherein the notice prompts the user to renew the user authentication information.

21. The method of claim 19, wherein the transaction is a specified type of transaction.

22. The method of claim 8, the business rules including criteria under which authentication information is required from the user.

23. The method of claim 8, the business rules including conditions under which the user renews the user authentication information.

24. The method of claim 23, the conditions including renewing the user authentication information for a transaction above a specified monetary amount.

25. The method of claim 23, wherein the conditions include renewing the user authentication information for a transaction within a specific geographic location or outside of a specific geographic location.

26. The method of claim 23, the conditions including renewing the user authentication information for a transaction after a specified number of transactions has taken place.

27. The method of claim 23, the conditions including renewing the user authentication information for a transaction occurring within a specified time period from another transaction.

28. The method of claim 23, wherein the business rules are maintained within a user profile associated with the user authentication account.

29. A non-transitory computer-readable storage device having embedded therein a set of instructions which, when executed by one or more processors of said computer causes said computer to execute the operations comprising:
receiving data from a user, the data including (1) data to establish a user authentication account, and (2) a set of business rules established by the user to manage the user authentication account;
establishing a user authentication account; and
managing the user authentication account using the business rules, the managing the user authentication account including providing authentication services and associated services.

30. The computer-readable storage device of claim 29, the business rules including the requirement that the user receive notice of a transaction before the transaction is carried out.

31. The computer-readable storage device of claim 30 further including prompting the user to enter authentication information.

32. The computer-readable storage device of claim 29, the business rules including the requirement that the user receive notice of a transaction after the transaction is carried out.

33. The computer-readable storage device of claim 32 wherein the notice prompts the user to renew the user authentication information.

34. The computer-readable storage device of claim 29, the business rules including criteria under which authentication information is required from the user.

35. The computer-readable storage device of claim 29, the business rules including conditions under which the user renews the user authentication information.

36. The computer-readable storage device of claim 35, the conditions including renewing the user authentication information for any transaction above a specified monetary amount.

37. The computer-readable storage device of claim 35, the conditions including renewing the user authentication information for any transaction within a specific geographic location or outside of a specific geographic location.

38. The computer-readable storage device of claim 35, the conditions including renewing the user authentication information for any transaction after a specified number of transactions has taken place.

39. The computer-readable storage device of claim 35, the conditions including renewing the user authentication information for a transaction occurring within a specified time period from another transaction.
